(19) United States
(12) Patent Application Publication
(10) Pub. No.: US 2022/0318590 A1
(43) Pub. Date: Oct. 6, 2022

(54) EQUIVARIANT STEERABLE CONVOLUTIONAL NEURAL NETWORKS

(71) Applicant: QUALCOMM Technologies, Inc., San Diego, CA (US)

(72) Inventors: Gabriele CESA, Diemen (NL); Leon LANG, Diemen (NL); Maurice WEILER, Amsterdam (NL)

(21) Appl. No.: 17/219,099

(22) Filed: Mar. 31, 2021

(51) Int. Cl. G06N 3/04; G06N 3/08

(52) U.S. Cl. CPC G06N 3/04; G06N 3/08

(57) ABSTRACT

A method comprising for generating an equivariant neural network includes receiving a set of irreducible representations for an origin-preserving group. A network that is equivariant to the origin-preserving group is dynamically generated based on the set of irreducible representation.

### BACKGROUND

### Field

Aspects of the present disclosure generally relate to artificial neural networks.

### Background

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Equivariance is becoming an increasingly popular design choice to build data efficient networks by exploiting prior knowledge about the symmetries of a given problem. Some conventional systems provide models equivariant to continuous three-dimensional (3D) rotations. To achieve continuous equivariance, these conventional systems encode the features of the network in a band-limited Fourier space and rely on specific non-linearities acting in this space. However, this parametrization combined with these non-linearities results in poor performance.

### SUMMARY

In an aspect of the present disclosure, a method is provided. The method includes receiving a set of irreducible representations for an origin-preserving group. The method also includes generating a network that is equivariant to the origin-preserving group based at least in part on the set of irreducible representations.

In an aspect of the present disclosure, an apparatus is provided. The apparatus includes a memory and one or more processors coupled to the memory. The processor(s) are configured to receive a set of irreducible representations for an origin-preserving group. The processor(s) are also configured to generate a network that is equivariant to the origin-preserving group based at least in part on the set of irreducible representations.

In an aspect of the present disclosure, an apparatus is provided. The apparatus includes means for receiving a set of irreducible representations for an origin-preserving group. The apparatus also includes means for generating a network that is equivariant to the origin-preserving group based at least in part on the set of irreducible representations.

In an aspect of the present disclosure, a non-transitory computer readable medium is provided. The computer readable medium has encoded thereon program code. The program code is executed by a processor and includes code to receive a set of irreducible representations for an origin-preserving group. The program code also includes code to generate a network that is equivariant to the origin-preserving group based at least in part on the set of irreducible representations.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 illustrates a method for operating a neural network to provide equivariant three-dimensional isometries, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed, equivariance is becoming an increasingly popular design choice to build data efficient networks by exploiting prior knowledge about the symmetries of a given problem. Equivariance is a form of symmetry for functions from one space with symmetry to another. In other words, equivariance is a property directly relating input transformations to feature transformations. A network may be considered equivariant if the network produces representations that transform in a predictable linear manner under transformations of the input.

Some conventional systems provide models equivariant to continuous three-dimensional (3D) rotations. Three-dimensional equivariance has applications in numerous technologies including, for example, computational chemistry, medical imaging, and 3D vision with volumetric data such as object recognition, occupancy fields, and point clouds.

To achieve continuous equivariance, these conventional systems encode the features of the network in a band-limited Fourier space and rely on specific non-linearities acting in this space. However, this parametrization combined with these non-linearities results in poor performance.

Accordingly, aspects of the present disclosure are directed to models equivariant to 3D isometries. Isometries are the transformations or mappings of a metric space onto itself such that the distance between any two points in the original space is the same as the distance between their images in the second space. Three-dimensional isometries include translations, rotations and reflections (mirroring), for example.

In some aspects, group restrictions leverage larger symmetries in the lower layers at the small scale (e.g., locally) when input data is not globally symmetric (e.g. diffusion MRI scan of brain).

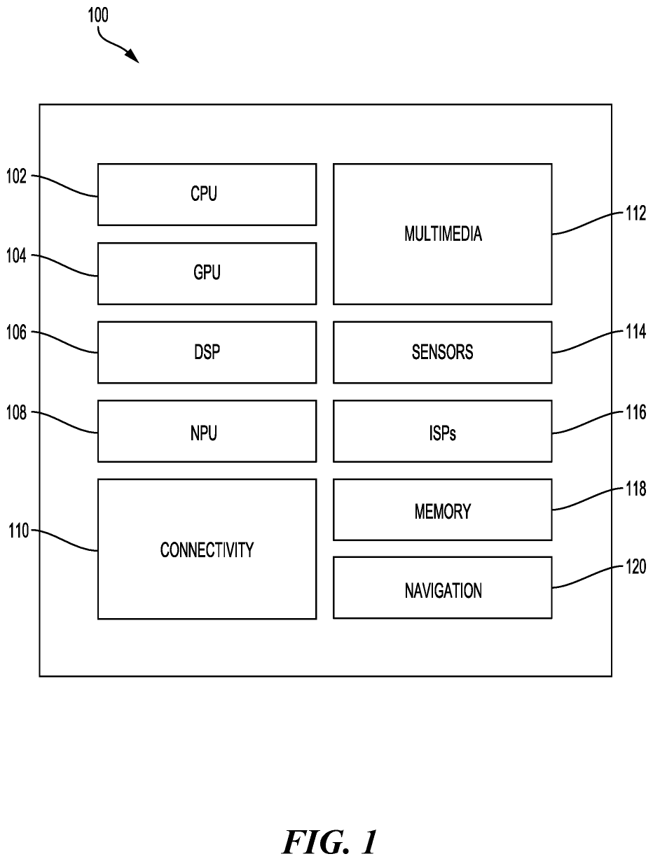

FIG. 1 illustrates an example implementation of a system-on-a-chip (SOC) 100, which may include a central processing unit (CPU) 102 or a multi-core CPU configured for generating an equivariant neural network. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a set of irreducible representations for an origin-preserving group. The general-purpose processor 102 may also include code to generate a network that is equivariant to the origin-preserving group based at least in part on the set of irreducible representation.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

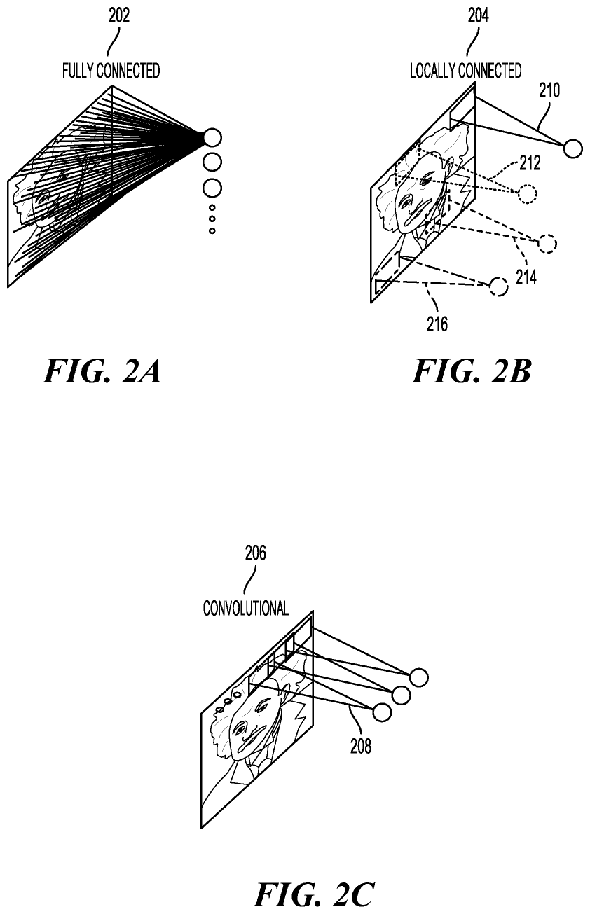

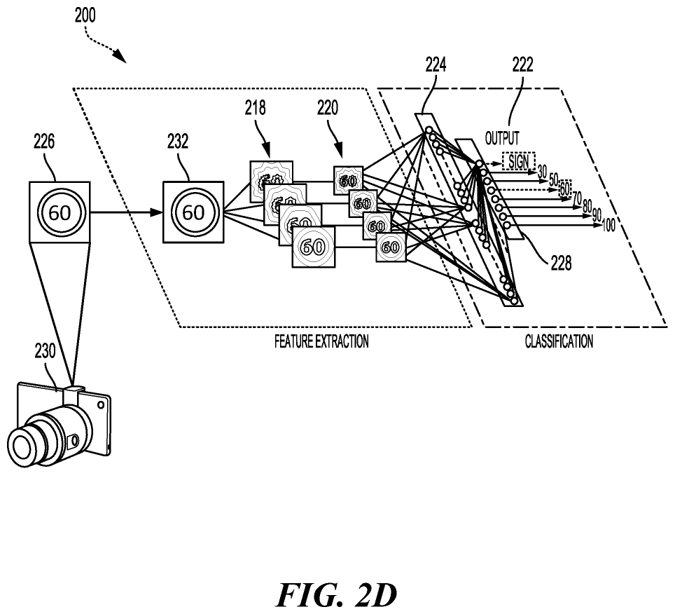

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

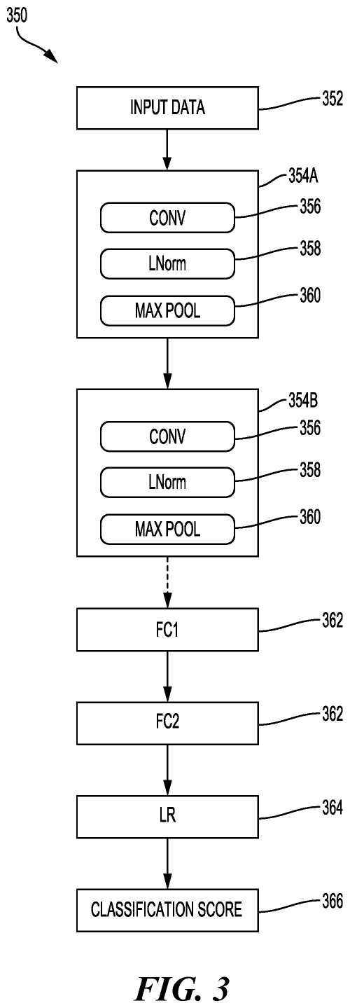

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

Aspects of the present disclosure are directed to generating models equivariant to three-dimensional (3D) rotations and reflections.

Steerable convolutional neural networks (CNNs) represent their inputs as fields over a homogenous space (e.g., [symbol] ³) and use steerable filters to map between such representations. Given a feature space with a group representation (F, π) and a convolutional network Φ:F→F′, the feature space F′ is linearly steerable with respect to G, if for all transformations [symbol] ∈ G, the features Φf and Φπ(g)f are related by a linear transformation π′(g) that does not depend on f.

Steerable CNNs may enable an efficient implementation of neural networks equivariant to groups of the form G= [symbol] ^{d} [symbol] H, where the group H<0 (d) is a group of isometries of the Euclidean space [symbol] ^{d} that preserves its origin and [symbol] is the inner semidirect product operator. This framework is based on the interpretation of a convolutional feature as a feature field, such as, for example, a feature map f: [symbol] ³→ [symbol] ^{c} associated with a group representation p:H→ [symbol] ^{c×c} defining the transformation law of the feature map f under the action of an element g=(t, h) ∈ G, with t ∈ [symbol] ³ and h ∈ H:

[g.f](x)=ρ(h)f(h⁻¹ (x−t)), (1)

where x is a point in a base space.

An equivariant network may be a convolutional neural network in which convolution layers use only kernels k satisfying a specific constraint defined by the group representations ρᵢₙ and ρₒᵤₜ of H associated with its own input and output feature fields as follows:

∀h ∈ H ∀x ∈ [symbol] ³ k(h.x)=ρₒᵤₜ(h)k(x)ρᵢₙ(h)^{T}. (2)

In accordance with aspects of the present disclosure, G is defined as an origin-preserving symmetry, where H is a subgroup of G. To parametrize any origin-preserving symmetry G<O(3) equivariant convolution layer, the kernel constraint of Equation 2 may be solved for any pair of irreducible representations (may also be referred to as “irreps”) of G. The number of different groups G<O(3) and the corresponding irreducible representation may render solving the constraints manually very time consuming and impractical. Accordingly, aspects of the present disclosure may determine these kernel constraints automatically. An H equivariant filter on [symbol] ⁿ may be determined by decomposing IV as the union of a number of subspaces [symbol] ⁿ=Uᵢ Xᵢ such that each subspace includes an independent orbit of points through the origin-preserving symmetry G, where Xᵢ={g.xᵢ|g ∈ G} for some xᵢ and Xᵢ∩Xⱼ, where i≠j. Thus, each Xᵢ corresponds to a homogeneous space for G. Accordingly, for a group G, the corresponding set of irreducible representations Ĝ, an input irreducible representation ψₗ:G→ [symbol] ^{|l|×|l|} ∈ Ĝ, an output irreducible representation ψ_{J}:G→ [symbol] ^{|J|×|J|} ∈ Ĝ and a homogeneous space X for G, may precisely describe the component k:X→ [symbol] ^{|J|×|l|} of a G-steerable filter k on a homogeneous space X in [symbol] ⁿ as:

k(x)=Σ_{j∈Ĝ} Σᵢ^{m}^{ⱼ} Σₛ^{|E}^{^{J}}^{|}Σₘ^{|j|}w_{k,j,s,i}Eₖ^{J}C Gₛ[J|l,j]ₘ Y_{X,j}ⁱ (x)ₘ, (3)

Where |J| and |l| indicate the size of the corresponding irreps rather than absolute values, Y_{x,j}ⁱ:X→ [symbol] ^{|j|} are harmonics of the homogeneous space X, mⱼ is the number of harmonics of X which are transforming according to the G-irrep ψⱼ, J(jl) is the number of times the irrep ψⱼ appears in the irreps decomposition of the tensor product ψₗ ⊗ ψⱼ, E_{J} is a set of |J|×|J| matrices containing a basis for the space for the space of endormorphisms of ψⱼ (and |E^{J}| is its cardinality) and CGₛ[J|l,j|]ₘ ∈ [symbol] ^{|J|×|l|} is the tensor containing the Clebsh-Gordan coefficients of the decompositions of the tensor product ψₗ ⊗ψⱼ for the s-th occurrence of ψⱼ in it (and CGₛ[J|l,j|]ₘ ∈ [symbol] ^{|J|×|l|} is the m-th slice of it along the last dimension). The values w_{k,j,s,i} are the learnable weights.

In some aspects, the values w_{k,j,s,i} may be learnable based on the decomposition of [symbol] ⁿ as [symbol] ⁿ=∪ᵢ Xᵢ and the set of harmonics Y_{X,j}ⁱ for all homogeneous spaces X, all irreps ψⱼ ∈ Ĝ and occurrences i. Additionally, in some aspects, the values of w_{k,j,s,i} may be learnable based on the decomposition of the tensor product of irreps (both J(jl) and CG) and a basis for the endomorphism space of ψⱼ (i.e. E^{J}).

The tensor product decomposition may be computed numerically by phrasing the problem as a linear system and finding its kernel using singular value decomposition (SVD). A basis for the coefficients of the irrep may be selected such that the endomorphism space has a known basis when the classification of an irrep is in one of three categories.

Considering [symbol] ⁿ and G=SO(n) or G=O(n), [symbol] ⁿ may be decomposed as [symbol] ⁿ=X₀ ∪∪_{i>0} Xᵢ, where X₀={o} is the set including only the origin, while the spaces Xᵢ are n-dimensional spheres Sⁿ⁻¹ of increasing radius. As such, the steerable filters of the network may be constructed by merging an independent copy of the basis obtained for X=Sⁿ⁻¹ for each radius considered. For smaller subgroups G<O(n), an ad-hoc decomposition of [symbol] ⁿ may be used.

Where G is discrete, the homogenous spaces Xᵢ may also be discrete. However, in this case, the homogenous spaces Xᵢ may be less suitable to cover the continuous [symbol] ⁿ. To address this issue, an adapted version of the parameterization in Eq. 1 may be to parameterize G-steerable filters using a homogenous space X of a larger group G′ (e.g., G<G′). Accordingly, the solution for G′=SO(n) or G′=O(n) may parameterize steerable filters equivalent to other origin-preserving isometries G<G′.

Given a compact group G′, a subgroup G<G′, their set of irreps Ĝ and Ĝ′, an input irrep ψₗ:G→ [symbol] ^{|l|×|l|} ∈ G, an output irrep ψⱼ:G→ [symbol] ^{|J|×|J|} ∈ Ĝ and a homogeneous space X for, the component Λ:X→ [symbol] ^{|J|×|l|} of a G-steerable filter k on a G′-homogeneous space X in [symbol] ⁿ may be parameterized as:

$$vec ( κ ) ( x ) = {\sum }_{{j}^{′} ∈ \hat{{G}^{′}}} {\sum }_{{i}^{′}}^{{m}_{{j}^{′}}} {\sum }_{j ∈ \hat{G}} {\sum }_{t}^{[ {jj}^{′} ]} {\sum }_{s}^{{j}^{( l , J )}} {\sum }_{k}^{\vert {E}^{j} \vert} {W}_{{j}^{′} , {i}^{′} , j , t , s , k} {\vec{{CG}_{s}} [ j \vert l , J \vert ]}^{T} {E}_{k}^{j} {ID}_{t}^{{jj}^{′}} {Y}_{X , {j}^{′}}^{{i}^{′}} ( x ) \qquad ( 4 )$$

where Y_{X}_{_{j′}}^{i′}: X→ [symbol] ^{|j′|} are harmonics of the homogeneous space X, mj′ is the number of harmonics of X which are transforming according to the G′-irrep ψ_{j′}j(lJ) is the number of times the G irrep ψⱼ appears in the irreps decomposition of the tensor product ψₗ ⊗ψⱼ, Eⁱ is a set of |j|×|j| matrices having a basis for the space of endomorphisms of ψⱼ including the coefficients of the t-th occurrence of j in the G-irreps decomposition of the G′ irrep j′ when interpreted as a G-representation, CG_{S}[j|l,J| ∈ [symbol] ^{|j|×|l|×|J|}] is the tensor having the Clebsh-Gordan coefficients of the decomposition of the tensor product ψₗ ⊗ψⱼ for the s-th occurrence of ψⱼ in it and \vec{CG_{S}}[j|l,J| ∈ [symbol] ^{|j|×|l| . . . |J|}] is the vectorization of its second two dimensions. vec (Λ)(x): X→ [symbol] ^{|l|·|J|} is the vectorization of the matrix κ(x) ∈ [symbol] ^{|l|×|J|}. The values w_{j′,i′,j,t,s,k} are the learnable weights.

For instance, in the 3D setting, this parameterization may build steerable filters equivalent to the discrete symmetries of platonic solids, inversions, mirrorings, or rotations (e.g., continuous or discrete) along a single axis. This parameterization may generalize a method for parameterizing filters equivariant to discrete rotations in the 2D setting.

Moreover, the parameterization may be determined based on only the harmonics on the homogeneous spaces X for a few groups like SO(3) or O(3). In this case, the homogeneous spaces X may always be spheres, whose harmonics are well known.

However, in some aspects, it may be beneficial to consider smaller (non-discrete) groups G′<O(3) and to parameterize filters directly in terms of their homogeneous spaces. In one example, G′=SO(2), O(2), SO(2)×C₂ or O(2)×C₂ acting on [symbol] ³. These groups may represent the symmetries of cones or cylinders in the space, for instance. [symbol] ³ may be decomposed as the union of multiple copies of these symmetric objects. The harmonics for such spaces, however, may be less well-known.

Additionally, the space of functions over a homogeneous space for G may form useful representations of G that may describe the features of a model.

A homogeneous space X for a group G may be obtained as the quotient G/H where H<G is a subgroup of G and may be the stabilizer of X. The harmonics of X may be derived from the irreps of G. When restricting an irrep ψⱼ ∈ Ĝ to H, the mj columns of ψⱼ including a trivial representation of H (when ψ is decomposed in terms of the irreps of H) are the harmonics Y_{x,j}ⁱ for i=1, . . . , mj of X=G/H.

This result can be further generalized to a space of vector-valued functions over homogeneous spaces. A vector-valued function X is associated with an irrep ρ ∈ Ĥ. This space of functions corresponds to the induced representation Ind_{H}^{G} ρ. In this case, the harmonics are the columns of the irreps ψ ∈ Ĝ which includes ρ when restricted to H.

As discussed, equivariance to continuous groups H may be achieved by approximating it with finite subsets of the groups. In doing so, SO(3) features may be parameterized using a band-limited Fourier basis (i.e. Wigner D matrices), for example. Different types of sampling distributions and grids over the group may approximate a regular representation when applying pointwise non-linearities. Although, the group structure of the 3D rotations group SO(3) does not allow for discrete subgroups of arbitrary size, finite symmetries of the platonic solids, may form three different discrete subgroups of SO(3). The subgroups may include the tetrahedron T, the octahedron O, and the icosahedron I (or dodecahedron), respectively.

A formulation in terms of steerable filters may allow for a proper band-limiting of the convolutional kernel basis such that the discrete features can be interpreted as samples of continuous features over the rotations group SO(3). To do this, the irreducible representations of the discrete groups T, O, and I may be clarified in the restricted irreducible representations of SO(3).

In the planar case, the group of planar rotations SO(2) is isomorphic to the circle S¹. For example, the orbit of non-zero 2D point under rotations may appear to be the group SO(2) itself In 3D, instead the orbit may appear to be the 2-sphere S². A signal over the sphere f:S²→ [symbol] can be associated to the induced representation Ind_{SO(2)}^{SO(3)} 1 from the trivial representation 1:SO(2)→{1} of SO(2). This representation may be less expressive than the regular representation of SO(3) (because allows only for filters which are invariant to rotations along one axis). Nevertheless, it can be approximated with a grid over the 2-sphere, which uses fewer samples than a discretization of the full group SO(3) and, therefore, allows for a trade-off between the expressiveness (and the performance) of the model and computational cost.

To generalize the model designs described above to the group of 3D rotations and reflections O(3), induced representations Ind_{SO(2)}^{SO(3)}·of the SO(3) representations or Ind_{X}^{C}^{₂}^{×X} of the representations of the platonic groups X=T, O or I.

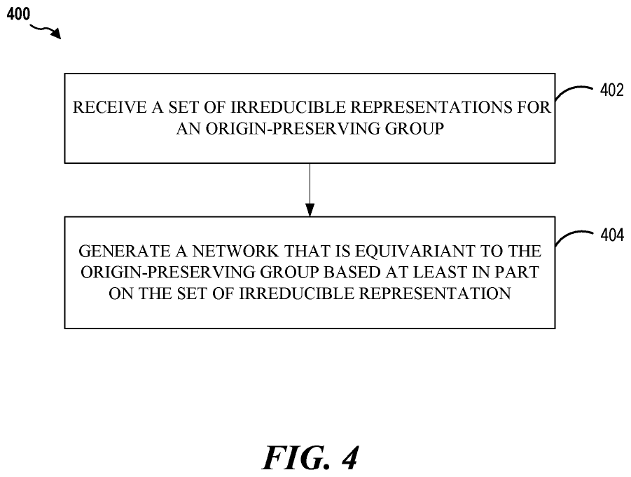

FIG. 4 illustrates a method 400, in accordance with aspects of the present disclosure. As shown in FIG. 4, at block 402, the method 400 receives a set of irreducible representations for an origin-preserving group. At block 404, the method 400 generates a network that is equivariant to the origin-preserving group based at least in part on the set of irreducible representation. As discussed, aspects of the present disclosure may determine these kernel constraints automatically. An H equivariant filter on [symbol] ⁿ may be determined by decomposing [symbol] ⁿ as the union of a number of subspaces [symbol] ⁿ=Uᵢ Xᵢ such that each subspace includes an independent orbit of points through the origin-preserving symmetry G, where Xᵢ={g.xᵢ|g ∈ G} for some xᵢ and Xᵢ∩Xⱼ, where i≈j. As such, each Xᵢ corresponds to a homogeneous space for G. Thus, for a group G, the corresponding set of irreducible representations Ĝ, an input irreducible representation ψₗG→ [symbol] ^{|l|×|l|} ∈ Ĝ, an output irreducible representation ψ_{J}:G→ [symbol] ^{|J|×|J|} ∈ Ĝ and a homogeneous space X for G, may precisely describe the component k:X→ [symbol] ^{|J|×|l|} of a G-steerable filter k on a homogeneous space X in [symbol] ⁿ.

Implementation examples are described in the following numbered clauses:
1. A method comprising:
   receiving a set of irreducible representations for an origin-preserving group; and
   generating a network that is equivariant to the origin-preserving group based at least in part on the set of irreducible representations.
2. The method of clause 1, in which the network comprises a steerable convolutional neural network.
3. The method of any of clauses 1-2, further comprising dynamically determine a set of kernel constraints to parameterize steerable filters of the network.
4. The method of any of clauses 1-3, further comprising determining a harmonic basis for homogeneous spaces based at least in part on the set of irreducible representations.
5. The method of any of clauses 1-4, in which weights of steerable filters of the network are learned based on a set of harmonics for the homogeneous spaces.
6. The method of any of clauses 1-5, further comprising operating the network to compute a transformation of a first point in a first space to a second point in a second space, based on the weights of the steerable filters.
7. The method of any of clauses 1-6, in which the group is approximated using finite symmetries of a platonic solid forming a discrete subgroup.
8. The method of any of clauses 1-7 in which the discrete subgroup is selected from a set of symmetry groups consisting of a tetrahedron, an octahedron and an icosahedron.
9. The method of any of clauses 1-7, in which the group is approximated based on a sampling distribution of volumetric data.
10. The method of any of clauses 1-9, further comprising applying a group restriction to impose equivariance based on a degree of symmetry of an input.
11. An apparatus, comprising:
   a memory; and
   at least one processor coupled to the memory, the at least one processor being configured:
      to receive a set of irreducible representations for an origin-preserving group; and
      to generate a network that is equivariant to the origin-preserving group based at least in part on the set of irreducible representations.

12. The apparatus of clause 11, in which the network comprises a steerable convolutional neural network.

13. The apparatus of any of clauses 11-12, in which the at least one processor is further configured to dynamically determine a set of kernel constraints to parameterize steerable filters of the network.

14. The apparatus of any of clauses 11-13, in which the at least one processor is further configured to determine a harmonic basis for homogeneous spaces based at least in part on the set of irreducible representations.

15. The apparatus of any of clauses 11-14, in which weights of steerable filters of the network are learned based on a set of harmonics for the homogeneous spaces.

16. The apparatus of any of clauses 11-15, in which the at least one processor is further configured to operate the network to compute a transformation of a first point in a first space to a second point in a second space, based on the weights of the steerable filters.

17. The apparatus of any of clauses 11-16, in which the at least one processor is further configured to approximate the group using finite symmetries of a platonic solid forming a discrete subgroup.

18. The apparatus of any of clauses 11-17, in which the discrete subgroup is selected from a set of symmetry groups consisting of a tetrahedron, an octahedron and an icosahedron.

19. The apparatus of any of clauses 11-17, in which the at least one processor is further configured to approximate the group based on a sampling distribution of volumetric data.
20. The apparatus of clause any of clauses 11-19, in which the at least one processor is further configured to apply a group restriction to impose equivariance based on a degree of symmetry of an input.
21. An apparatus, comprising:
   means for receiving a set of irreducible representations for an origin-preserving group; and
   means for generating a network that is equivariant to the origin-preserving group based at least in part on the set of irreducible representations.
22. The apparatus of clause 21, in which the network comprises a steerable convolutional neural network.
23. The apparatus of any of clauses 21-22, further comprising means for dynamically determine a set of kernel constraints to parameterize steerable filters of the network.
24. The apparatus of any of clauses 21-23, further comprising means for determining a harmonic basis for homogeneous spaces based at least in part on the set of irreducible representations.
25. The apparatus of any of clauses 21-24, in which weights of steerable filters of the network are learned based on a set of harmonics for the homogeneous spaces.
26. The apparatus of any of clauses 21-25, further comprising means for operating the network to compute a transformation of a first point in a first space to a second point in a second space, based on the weights of the steerable filters.
27. The apparatus of any of clauses 21-26, in which the group is approximated using finite symmetries of a platonic solid forming a discrete subgroup.
28. The apparatus of any of clauses 21-27, in which the discrete subgroup is selected from a set of symmetry groups consisting of a tetrahedron, an octahedron and an icosahedron.
29. The apparatus of any of clauses 21-27, in which the group is approximated based on a sampling distribution of volumetric data.
30. The apparatus of any of clauses 21-29, further comprising means for applying a group restriction to impose equivariance based on a degree of symmetry of an input.
31. A non-transitory computer readable medium having included thereon program code, the program code being executed by a processor and comprising:
   program code to receive a set of irreducible representations for an origin-preserving group; and
   program code to generate a network that is equivariant to the origin-preserving group based at least in part on the set of irreducible representations.
32. The non-transitory computer readable medium of clause 31, in which the network comprises a steerable convolutional neural network.
33. The non-transitory computer readable medium of any of clauses 31-32, further comprising program code to dynamically determine a set of kernel constraints to parameterize steerable filters of the network.
34. The non-transitory computer readable medium of any of clauses 31-33, further comprising program code to determine a harmonic basis for homogeneous spaces based at least in part on the set of irreducible representations.
35. The non-transitory computer readable medium of any of clauses 31-34 in which weights of steerable filters of the network are learned based on a set of harmonics for the homogeneous spaces.
36. The non-transitory computer readable medium of any of clauses 31-35, further comprising program code to operate the network to compute a transformation of a first point in a first space to a second point in a second space, based on the weights of the steerable filters.
37. The non-transitory computer readable medium of any of clauses 31-36, further comprising program code to approximate the group using finite symmetries of a platonic solid forming a discrete subgroup.
38. The non-transitory computer readable medium of any of clauses 31-37, in which the discrete subgroup is selected from a set of symmetry groups consisting of a tetrahedron, an octahedron and an icosahedron.
39. The non-transitory computer readable medium of any of clauses 31-37, further comprising program code to approximate the group based on a sampling distribution of volumetric data.
40. The non-transitory computer readable medium of any of clauses 31-39, further comprising program code to apply a group restriction to impose equivariance based on a degree of symmetry of an input.

In one aspect, the receiving means, means for generating a group representation, applying means and/or means for generating an output may be the CPU 102, program memory associated with the CPU 102, the dedicated memory block 118, fully connected layers 362, and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method comprising:
receiving a set of irreducible representations for an origin-preserving group; and
generating a network that is equivariant to the origin-preserving group based at least in part on the set of irreducible representations.

2. The method of claim 1, in which the network comprises a steerable convolutional neural network.

3. The method of claim 2, further comprising dynamically determine a set of kernel constraints to parameterize steerable filters of the network.

4. The method of claim 1, further comprising determining a harmonic basis for homogeneous spaces based at least in part on the set of irreducible representations.

5. The method of claim 4, in which weights of steerable filters of the network are learned based on a set of harmonics for the homogeneous spaces.

6. The method of claim 5, further comprising operating the network to compute a transformation of a first point in a first space to a second point in a second space, based on the weights of the steerable filters.

7. The method of claim 1, in which the group is approximated using finite symmetries of a platonic solid forming a discrete subgroup.

8. The method of claim 7, in which the discrete subgroup is selected from a set of symmetry groups consisting of a tetrahedron, an octahedron and an icosahedron.

9. The method of claim 7, in which the group is approximated based on a sampling distribution of volumetric data.

10. The method of claim 7, further comprising applying a group restriction to impose equivariance based on a degree of symmetry of an input.

11. An apparatus, comprising:
a memory; and
at least one processor coupled to the memory, the at least one processor being configured:
to receive a set of irreducible representations for an origin-preserving group; and
to generate a network that is equivariant to the origin-preserving group based at least in part on the set of irreducible representations.

12. The apparatus of claim 11, in which the network comprises a steerable convolutional neural network.

13. The apparatus of claim 12, in which the at least one processor is further configured to dynamically determine a set of kernel constraints to parameterize steerable filters of the network.

14. The apparatus of claim 11, in which the at least one processor is further configured to determine a harmonic basis for homogeneous spaces based at least in part on the set of irreducible representations.

15. The apparatus of claim 14, in which weights of steerable filters of the network are learned based on a set of harmonics for the homogeneous spaces.

16. The apparatus of claim 15, in which the at least one processor is further configured to operate the network to compute a transformation of a first point in a first space to a second point in a second space, based on the weights of the steerable filters.

17. The apparatus of claim 11, in which the at least one processor is further configured to approximate the group using finite symmetries of a platonic solid forming a discrete subgroup.

18. The apparatus of claim 17, in which the discrete subgroup is selected from a set of symmetry groups consisting of a tetrahedron, an octahedron and an icosahedron.

19. The apparatus of claim 17, in which the at least one processor is further configured to approximate the group based on a sampling distribution of volumetric data.

20. The apparatus of claim 17, in which the at least one processor is further configured to apply a group restriction to impose equivariance based on a degree of symmetry of an input.

21. An apparatus, comprising:
means for receiving a set of irreducible representations for an origin-preserving group; and
means for generating a network that is equivariant to the origin-preserving group based at least in part on the set of irreducible representations.

22. The apparatus of claim 21, in which the network comprises a steerable convolutional neural network.

23. The apparatus of claim 22, further comprising means for dynamically determine a set of kernel constraints to parameterize steerable filters of the network.

24. The apparatus of claim 21, further comprising means for determining a harmonic basis for homogeneous spaces based at least in part on the set of irreducible representations.

25. The apparatus of claim 24, in which weights of steerable filters of the network are learned based on a set of harmonics for the homogeneous spaces.

26. The apparatus of claim 25, further comprising means for operating the network to compute a transformation of a first point in a first space to a second point in a second space, based on the weights of the steerable filters.

27. A non-transitory computer readable medium having included thereon program code, the program code being executed by a processor and comprising:
program code to receive a set of irreducible representations for an origin-preserving group; and
program code to generate a network that is equivariant to the origin-preserving group based at least in part on the set of irreducible representations.

28. The non-transitory computer readable medium of claim 27, in which the network comprises a steerable convolutional neural network and further comprising program code to dynamically determine a set of kernel constraints to parameterize steerable filters of the network.

29. The non-transitory computer readable medium of claim 27, further comprising program code to determine a harmonic basis for homogeneous spaces based at least in part on the set of irreducible representations.

30. The non-transitory computer readable medium of claim 29, in which weights of steerable filters of the network are learned based on a set of harmonics for the homogeneous spaces.
